(19) United States
(12) Patent Application Publication
(10) Pub. No.: US 2026/0227809 A1
(43) Pub. Date: Aug. 6, 2026

(54) PRIMED PNEUMATIC CONTROL OF PROCESS GAS REGULATOR

(71) Applicant: The ESAB Group, Inc., North Bethesda, MD (US)

(72) Inventor: Erik Anthony Leger, Peterborough, NH (US)

(21) Appl. No.: 19/045,860

(22) Filed: Feb. 5, 2025

Related U.S. Application Data
(63) Continuation of application No. PCT/US2023/072189, filed on Aug. 15, 2023.
(60) Provisional application No. 63/398,412, filed on Aug. 16, 2022.

(51) Int. Cl. G05D 16/20; H05H 1/26

(52) U.S. Cl. CPC G05D 16/2024; G05D 16/204; H05H 1/26

(57) ABSTRACT

A pneumatic system for nearly instantaneously controlling process gas for an arc process torch. The pneumatic system includes an electro-pneumatic regulator and a three-way valve for pneumatically controlling a pilot signal for a pilot regulator. The pilot regulator controls a pressure of a process gas supplied to an arc process torch.

### CROSS-REFERENCE TO RELATED APPLICATIONS

This application is a continuation application of, and claims the benefit of and priority to, International Patent Application No. PCT/US2023/072189, entitled “PRIMED PNEUMATIC CONTROL OF PROCESS GAS REGULATOR,” filed on Aug. 15, 2023, Attorney Docket No. 1485.1041, which claims priority to U.S. Provisional Patent Application No. 63/398,412, entitled “ANTICIPTED LINE PRIMING FOR PLASMA GAS CONTROL,” filed Aug. 16, 2022, Attorney Docket No. 1485.1041P. The entire disclosures of both of the above-identified applications are incorporated by reference herein in their entireties for all purposes.

### FIELD OF INVENTION

The present disclosure is directed toward an arc process (e.g., cutting or welding) system and, in particular, a system for priming gas supply lines for an automated plasma cutting torch.

### BACKGROUND

Generally, during a plasma cutting operation, it is important to control the process gas pressure based on the current of the arc. This is because the current generates a substantial amount of heat that can potentially melt a hafnium insert at the operating end of the electrode, while the plasma gas pressure can prevent melted hafnium from falling out of the electrode tip. Moreover, if gas pressure is not controlled based on arc current, the hafnium may spatter in response to an increase in current. Alternatively, the melted hafnium can solidify in a deformed manner when the current decreases. Thus, in many plasma cutting systems, the plasma gas pressure often increases as the current increases to hold the hafnium in place and cool it to prevent spattering. Likewise, the gas pressure often decreases as the current decreases to allow the hafnium to properly solidify without deforming or being blown out of the electrode tip.

Typically, conventional systems use the power supply to control gas pressure(s) in the system (e.g., plasma gas, shield gas, and/or other process gases) and changes in gas pressure must be carefully planned well in advance of a change in current of the plasma arc. For example, gas pressures can be planned based on a length of hose or cable between the torch and gas supply at the power source. That is, the longer the hose between the gas source and the torch, the greater the amount of time to charge the gas pressure within the hose. Consequently, when using long hoses, changes in current must also be planned well in advance to prevent a mismatch of current and gas pressure. Then, to achieve the change, gas lines may be pre-charged for a period of time prior to a change, but this pre-charging can change the pressure of a gas (e.g., the plasma gas pressure) prior to the next stage of a cutting operation, which can cause damage to the torch tip and/or degrade cut quality.

Despite the foregoing disadvantages of pre-planning and pre-charging gas lines (e.g., cable hose) that extend between a power supply and a torch, these techniques continued to be in widespread use at least because electromagnetic interference (EMI) generated by the arc between the torch and workpiece often prevents reliable control of a pressure regulator at the torch via electrical signals. That is, the EMI may disrupt electrical signals sent between the torch pressure regulator and power supply. Therefore, the power supply cannot reliably control the gas pressure at the torch with an electrically controlled pressure regulator or valve.

### SUMMARY OF THE INVENTION

In one embodiment, a process gas control system for a plasma torch comprises a gas source, a first regulator connected to the gas source, a valve component having three modes of operation, a first line connected to the first regulator and to the valve component, the first line supplying a gas from the first regulator to the valve component, the gas in the first line being at a first pressure, a second regulator, and a second line connected to the valve component and to the second regulator, the second line supplying a gas from the valve component to the second regulator, the gas in the second line being at a second pressure, wherein the valve component controls the second pressure in the second line.

In another aspect, the first line is a pneumatic control line and the second line is a pneumatic pilot line.

In another aspect, the three modes of operation of the valve component are an open mode, a hold mode, and a vent mode.

In another aspect, in the open mode, the valve component fluidly couples the first regulator to the second regulator via the first line and the second line.

In another aspect, in the hold mode, the valve component closes off the first line and the second line, and the gas in the first line can be adjusted by the first regulator to be at a third pressure while the second line is held at the second pressure.

In another aspect, in the vent mode, the second line can be vented to reduce a pressure of the second regulator and a pressure of gas in a line downstream of the second regulator.

In another aspect, the first regulator is an electro-pneumatic regulator that is closer to the gas source than to the plasma torch, and the valve component is closer to the plasma torch than to the gas source.

In another aspect, the valve component is a three-way valve.

In another embodiment, a process gas control system for a plasma torch comprises a gas source, a first regulator connected to the gas source, a three-way valve having a plurality of operational modes, a first pneumatic line connected to the first regulator and to the three-way valve, the first pneumatic line supplying a gas from the first regulator to the three-way valve, a second regulator, a second pneumatic line connected to the three-way valve and to the second regulator, the second pneumatic line supplying a gas from the three-way valve to the second regulator, and a process gas line downstream of the second regulator, wherein a pressure of gas in the second pneumatic line and a pressure of gas in the process gas line can be adjusted relative to a pressure of gas in the first pneumatic line by the three-way valve being in a particular one of its plurality of operational modes.

In one aspect, the first regulator is an electro-pneumatic regulator that is closer to the gas source than to the plasma torch, and the three-way valve is proximate to the plasma torch.

In yet another embodiment, a method of operating a process gas control system for a plasma torch, the process gas control system including a gas source, a valve component, a first pneumatic line upstream of and connected to the valve component and supplying a gas from the gas source to the valve component, a second pneumatic line downstream of and connected to the valve component, and the method comprises the steps of controlling the valve component to be in an open position, adjusting gas in the first pneumatic line to be a first pressure, fluidly coupling the first pneumatic line to the second pneumatic line so that a pressure of gas in the second pneumatic line is at the first pressure, and upon determining that the gas in the second pneumatic line is at the first pressure, controlling the valve component to be in a hold position.

In one aspect, the process gas control system includes a pilot regulator connected to the second pneumatic line, and when the valve component is in the hold position, each of a pressure of gas in the first pneumatic line and a pressure of gas in the pilot regulator is maintained at the first pressure.

In another aspect, the process gas control system includes a process gas line downstream of the pilot regulator, and when the valve component is in the hold position, the method further comprises the step of regulating, via the pilot regulator, a pressure of process gas in the process gas line to be at the first pressure.

In another aspect, when the valve component is in the hold position, the method further comprises the step of adjusting the gas in the first pneumatic line to be at a second pressure different from the first pressure without affecting the pressure of the process gas in the process gas line.

In another aspect, the process gas control system includes an electro-pneumatic regulator upstream of the valve component, and the method further comprises the step of controlling the valve component to be in the open position so that the electro-pneumatic regulator and the first pneumatic line are fluidly coupled with the second pneumatic line and the pilot regulator, and a pressure of the gas in the second pneumatic line quickly adjusts to the second pressure.

In another aspect, when the pressure of the gas in the second pneumatic line is at the second pressure, the pilot regulator substantially immediately changes a pressure of the gas in the process gas line to the second pressure.

In another aspect, method further comprises the step of controlling the valve component to the hold position, wherein a pressure of gas in the second pneumatic line, a pressure of gas in the pilot regulator, and a pressure of gas in the process gas line are maintained at the second pressure.

In another aspect, the method further comprises the step of controlling the electro-pneumatic regulator to adjust a pressure of gas in the first pneumatic line to be at a third pressure for a subsequent cutting operation.

In another aspect, the method further comprises the step of controlling the valve component to a vent position to lower a pressure of gas in the second pneumatic line and the pilot regulator to a fourth pressure by venting at least some of the gas in the second pneumatic line to atmosphere.

In another aspect, when gas in the second pneumatic line reaches the fourth pressure, the method further comprises the step of controlling the valve component back to the hold position.

### BRIEF DESCRIPTION OF THE DRAWINGS

To complete the description and in order to provide for a better understanding of the techniques presented in this application, a set of drawings is provided. The drawings form an integral part of the description and illustrate an embodiment of the present application, which should not be interpreted as restricting the scope of the present application, but just as an example of how the techniques presented herein can be carried out. The drawings comprise the following figures:

FIG. 1A is a perspective view of an automated cutting system having a pneumatic control system that may execute the techniques presented herein, according to an example embodiment of the present disclosure.

FIG. 1B is perspective view of an automated cutting head that may be included in the automated cutting system illustrated in FIG. 1A, according to an example embodiment of the present disclosure.

FIG. 1C is a schematic, cross-sectional view of an end portion of a plasma torch.

FIG. 2 is a schematic of the pneumatic control system of FIG. 1A, according to an example embodiment of the present disclosure.

FIG. 3 is a hardware block diagram of a computing device that may execute the techniques presented herein, according to an example embodiment of the present disclosure.

Like reference numerals have been used to identify like elements throughout this disclosure.

### DETAILED DESCRIPTION

The following description is not to be taken in a limiting sense but is given solely for the purpose of describing the broad principles of the invention. Embodiments of the invention will be described by way of example, with reference to the above-mentioned drawings showing elements and results according to the present invention.

The techniques presented herein are directed to changing a pressure of a process gas using a pneumatic pilot regulator rather than an electrically controlled valve or valve component. In cases where an environment is detrimental for electronic signal transmission (e.g., due to EMI), pneumatic pilot control of process gas pressures/flows is an inert option for signal transmission. For example, a pilot regulator controlled by pneumatic pilot control lines that conduct air can be used to regulate a process gas pressure without being affected by EMI. To achieve this, pneumatic control lines can extend from the power supply along the torch lead or cable and connect to pilot regulators at the point of use. Then, the pilot regulators regulate the pressure of a primary process gas line to the torch by setting a process gas line pressure to the same pressure as is pneumatically present in the regulator's pilot chamber.

In one embodiment, a set of vent/hold/open functionalities are implemented into a pneumatic pilot line of a process gas control system, which may be piloted by a pneumatic control signal set at a distance from the point of use, in an effort to produce a near instantaneous fluid signal response. In one embodiment, hardware and software may be embedded into a pneumatically piloted process gas control circuit which allows the capability to prime, vent, and hold dynamic process gas pressures at the torch end of a plasma cutter, while simultaneously allowing the pneumatic control signal from an extended distance away to equilibrate pressure along its length. Once equilibrated to proper control pressure, the remaining isolated control line and pilot control volume may be reconnected, which results in a near instantaneous pressure equilibration between a long distance pneumatic control line and a pilot control volume of interest. The remaining isolated control volume may also be vented directly to atmosphere for minimal latency time between fluid control signal and resultant point of use dynamic pressure response.

However, when utilizing pneumatic signal transmission, response time quickly becomes a problem over greater transmission distances. More specifically, due to the length between the power supply and the torch, there may be a lag between setting the pressure of the pressure regulator and charging the hose to a desired pressure. That is, air traveling through the hoses may take time to equilibrate in systems prone to high frictional loss (such as long, small diameter tubing, cables, or leads). This equilibration time chokes the responsiveness and limits control precision of pneumatic control systems.

Generally, the techniques described herein provide immediate control of a process gas at the torch via a pneumatic control system. The pneumatic control systems includes a pilot regulator at or near the torch for regulating the process gas pressure and an electro-pneumatic regulator fluidly coupled to a three-way valve via a pneumatic line. The three-way valve may allow the electro-pneumatic regulator to charge a cable at a first pressure while maintaining the pilot regulator, and thus the process gas, at a second pressure. Thus, the three-way valve may actuate and fluidly couple the charged cable with the pneumatic regulator, thereby nearly instantaneously setting a pressure of the pneumatic regulator to the first pressure. As noted above, the pneumatic pilot regulator is not affected by EMI. Consequently, the pilot regulator, and thus the process gas, may be reliably controlled and pressures within the torch may be adjusted instantaneously or nearly instantaneously without disruption from EMI generated by the torch arc.

In one embodiment, by utilizing an electronic control valve having a three-port, three-position construction, and by placing the valve at a point of use between the pilot chamber of a control regulator and the transmission lead, a single control parameter can be used account for the response time associated with any length of lead. In one aspect, the control signal is pneumatic in nature and is EMI-inert. This signal may be terminated at the point of use by a valve that has solenoids specified to operate with an alternating current (which is EMI-resistant).

Depending on the selected operational mode of the valve, the valve can serve as either a connective path (between a pilot control lead and a pilot chamber), a closed center (in which all lines are isolated and closed), or a vented pilot chamber (between a pilot chamber to atmosphere). Thus, a gas at a given pressure can be vented directly out of the pilot chamber for very high pressure relief response speed.

The pilot chamber can be isolated from the rest of the control line for independently setting the pressure at a distance and allowing for lead equilibration without interrupting or affecting state of process gas pressure or flow. Then the pilot chamber can be returned to have continuity with the control lead and equilibrate very quickly with the set pressure. In one embodiment, the system has the ability to predict by some time interval when the pressure needs to be changed or vented. This prediction is possible in a plasma cutting gas control process, as most automated processes involve the use of a machine language code, which is post processed and thus retains this retrospective control information.

In one aspect, the system disclosed herein allows for process gas control to be at or very close to point of use (which in one embodiment is a plasma torch), while mitigating any effects of EMI on the signal transmission for pressure and/or flow control, while simultaneously allowing for near instantaneous fluidic response precision given a simple and general control post processed gas control delay in the machine language code.

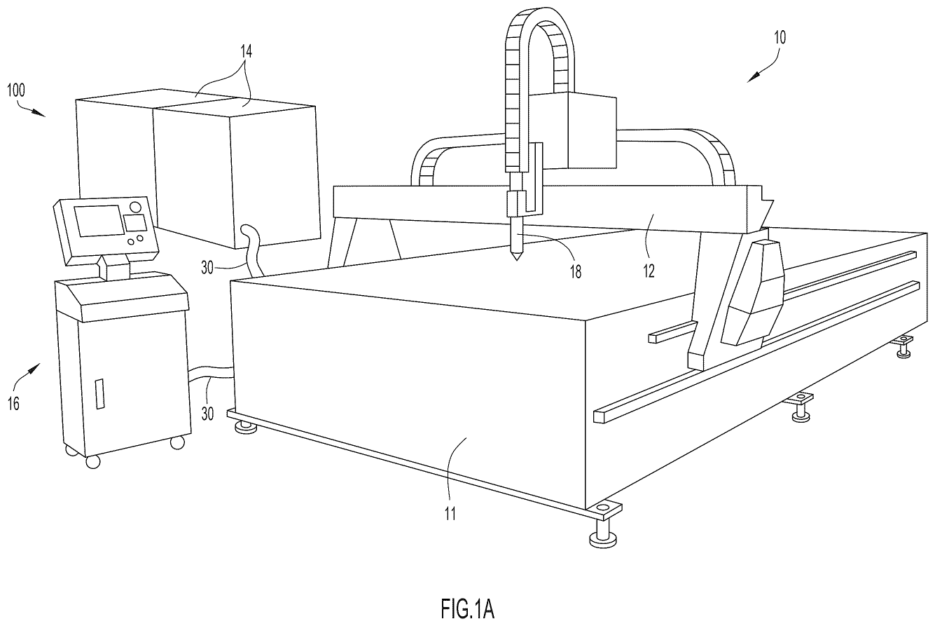

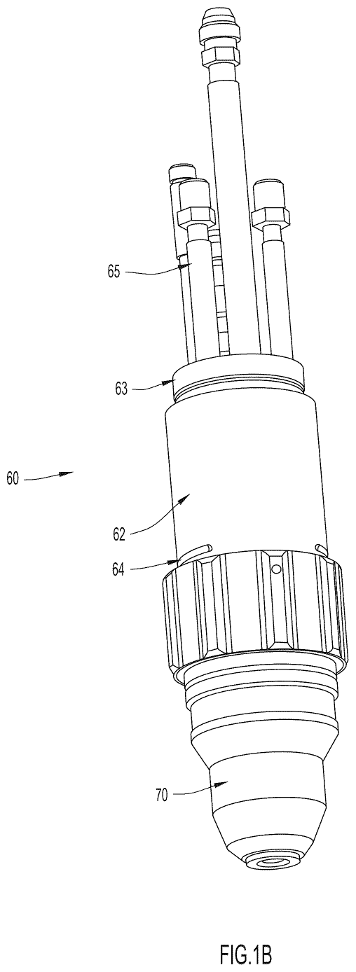

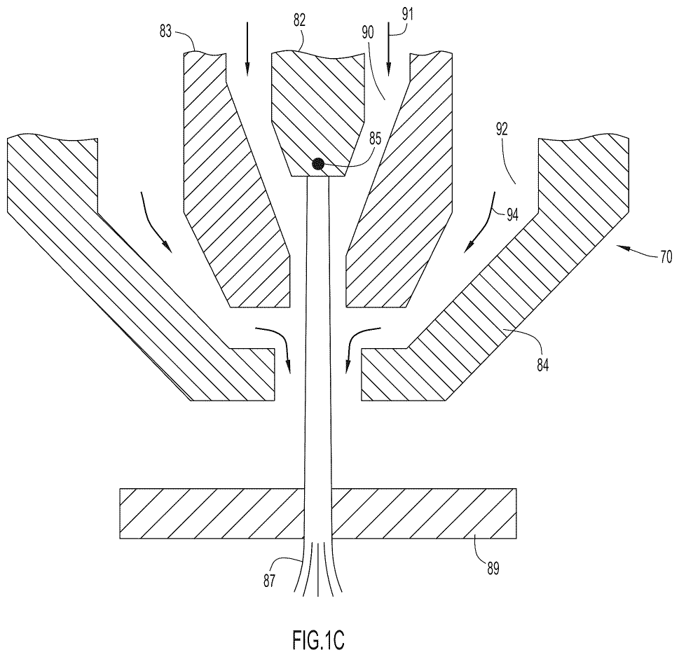

FIG. 1A illustrates an example embodiment of an automated cutting system 10 that may execute the techniques presented herein. However, this automated cutting system 10 is merely presented by way of example and the techniques presented herein may also be executed by manual cutting systems and/or automated cutting systems that differ from the automated cutting system 10 of FIG. 1A (e.g., any robotic or partially robotic cutting system). That is, the cutting system 10 illustrated in FIG. 1A is provided for illustrative purposes.

At a high-level, the cutting system 10 includes a table 11 configured to receive a workpiece (not shown), such as, but not limited to, sheets of metal. The automated cutting system also includes a positioning system 12 that is mounted to the table 11 and configured to translate or move along the table 11. At least one automated plasma arc torch 18 is mounted to the positioning system 12 and, in some embodiments, multiple automated plasma arc torches 18 may be mounted to the positioning system 12. The positioning system 12 may be configured to move, translate, and/or rotate the torch 18 in any direction (e.g., to provide movement in all degrees of freedom).

Additionally, at least one power supply 14 is operatively connected to the automated plasma arc torch 18 and configured to supply (or at least control the supply of) electrical power and flows of one or more fluids to the automated plasma arc torch 18 for operation. Also, a controller or control panel 16 is operatively coupled to and in communication with the automated plasma arc torch 18, the one or more power supplies 14, and the positioning system 12. The controller 16 may be configured to control the operations of the automated plasma arc torch 18, one or more power supplies 14, and/or the positioning system 12, either alone or in combination with the one or more power supplies 14. The controller 16 and power supply 14 may be fluidly and/or electrically connected to each other, the positioning system 12, and/or the plasma arc torch 18 via one or more conduits, leads, or cables 30.

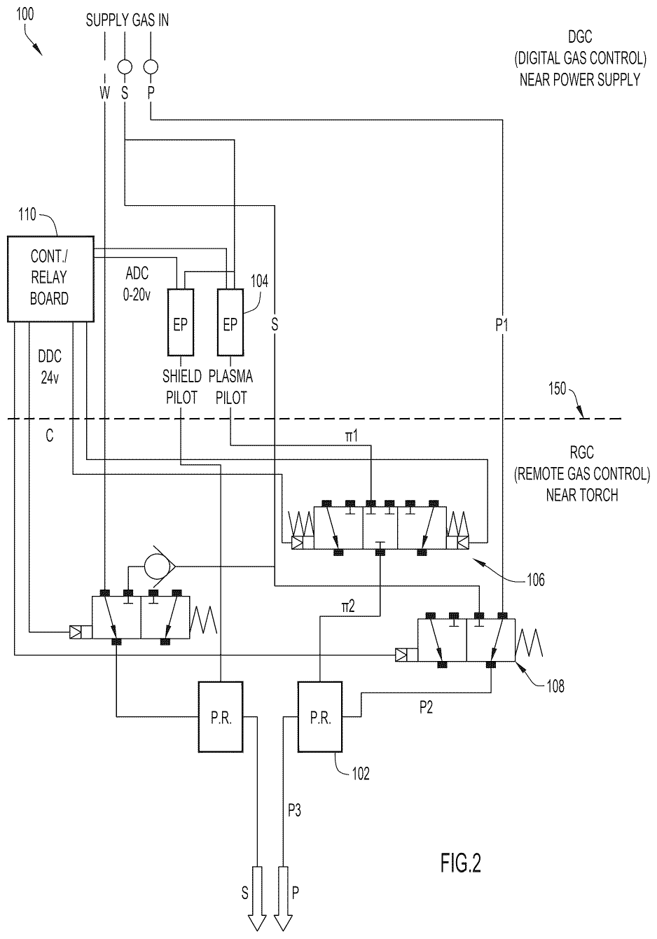

A pneumatic control system 100 controls the one or more flows of fluid to the automated plasma arc torch 18. The pneumatic control system 100 may include one or more cables 30, and one or more processors disposed in the controller 16 and/or the one or more power supplies 14. In some implementations, the system 100 may further include an electro-pneumatic regulator, a valve, a pilot regulator, and the torch 18. In some instances, one or more of the valve and the pilot regulator may be disposed in the torch 18, and the electro-pneumatic regulator may be disposed in the one or more power supplies 14 and/or the controller 16. The system 100 is discussed in further detail below with reference to FIG. 2.

In at least some embodiments, the one or more power supplies 14 meter one or more flows of fluid received from one or more fluid supplies before or as the one or more power supplies 14 supply gas to the torch 18 via the pneumatic control system 100. Additionally, or alternatively, the automated cutting system 10 may include a separate fluid supply unit (not shown) or units that can provide one or more fluids to the automated torch 18, via the pneumatic control system 100, independent of the one or more power supplies 14. To be clear, as used herein, the term “fluid” shall be construed to include a gas or a liquid. The one or more power supplies 14 may also condition, meter, and supply power to the automated torch 18 via the one or more cables 30, which may be integrated with, bundled with, or provided separately from cables 30 for fluid flows. Additional cables 30 for data, signals, and the like may also interconnect the controller 16, the automated plasma arc torch 18, the power supply 14, and/or the positioning system 12. Any cable 30 or cable conduit/hose/lead included in the automated cutting system 10 may be any length. Moreover, each end of any cable 30 or cable conduit/hose/lead may be connected to components of the automated cutting system 10 via any connectors now known or developed hereafter (e.g., via releasable connectors).

FIG. 1B illustrates an example embodiment of an automated cutting head 60 that may be used with an automated cutting system executing the techniques presented herein (e.g., the cutting system 10 of FIG. 1A). As can be seen, the cutting head 60 includes a body or torch body 62 that extends from a first end 63 (e.g., a connection end 63) to a second end 64 (e.g., an operating or operative end 64). The connection end 63 of the body 62 may be coupled (in any manner now known or developed hereafter) to an automation support structure (e.g., a cutting table, robot, gantry, etc., such as positioning system 12). Meanwhile, conduits 65 extending from the connection end 63 of the body 62 may be coupled to like conduits in the automation support structure (e.g., positioning system 12) to connect the automated cutting head 60 to a power supply, one or more fluid supplies, a coolant supply, and/or any other components supporting automated cutting operations.

At the other end, the operative end 64 of the body 62 may receive interchangeable components, including consumable components 70 that facilitate cutting operations. For simplicity, FIGS. 1A and 1B do not illustrate connections portions of the body 62 that allow consumable components 70 to connect to the torch body 62 in detail. However, it should be understood that the cutting consumables may be coupled to a torch body 62 in any manner. Moreover, to be clear, the consumable stack 70 depicted in FIG. 1B (with an external perspective view) is merely representative of a consumable stack that may be used with an automated torch executing the techniques presented herein. Similarly, while none of the Figures of the present application illustrates an interior of torch body 62, it is to be understood that any unillustrated components that are typically included in a torch, such as components that facilitate cutting operations, may be included in a torch executing example embodiments of the present application.

Now turning to FIG. 1C, this Figure is a simplified/schematic illustration of the consumable stack 70 of FIG. 1B. As mentioned, FIG. 1C only illustrates select components or parts that allow for a clear and concise illustration of the techniques presented herein. Thus, in FIG. 1C, only an electrode 82, a nozzle 83, and a shield cap 84 of the consumable stack 70 are depicted. As can be seen, the electrode 82 is disposed at a center of the consumable stack 70 and includes an emitter 85 (e.g., formed from hafnium, tungsten, and/or other emissive materials) at a distal end portion thereof. The nozzle 83 is generally positioned around the electrode 82. In some embodiments, the nozzle 83 is installed after the electrode 82. Alternatively, the electrode 82 and nozzle 83 can be installed onto the torch body 62 as a single component (e.g., these components may be coupled to each other and installed on/in the torch body collectively). In either case, the nozzle 83 may be spaced from the electrode 82; or, at least a distal portion of the nozzle 83 may be spaced apart from the distal portion of the electrode 82.

The shield 84 is positioned radially exteriorly of the nozzle 83 and is spaced apart from the nozzle 83, at least at its distal end. In some embodiments, the shield 84 is installed around an installation flange of the nozzle 83 in order to secure nozzle 83 and electrode 82 in place at (and in axial alignment with) an operating end of the torch body. Additionally or alternatively, the nozzle 83 and/or electrode 82 can be secured or affixed to a torch body in any desirable manner, such as by mating threaded sections included on the torch body with corresponding threads included on the components. For example, in some implementations, the electrode 82, nozzle 83, shield 84, as well as any other components (e.g., a lock ring, spacer, secondary cap, etc.) may be assembled together in a cartridge that may be selectively coupled to the torch body (e.g. by coupling the various components to a cartridge body or by coupling the various components to each other).

In use, a plasma torch is configured to emit a plasma arc 87 between the electrode 82 and a workpiece 89 to which a work lead associated with a power supply is attached (not shown). As shown in FIG. 1C, the nozzle 83 is spaced a distance away from the electrode 82 so that a plasma gas flow channel 90 is disposed therebetween. During piercing and cutting operations, a plasma gas 91 flows through the plasma gas flow channel 90. The shield 84 is also spaced a distance away from the nozzle 83 so that a shield flow channel 92 is disposed between the shield 84 and the nozzle 83. A shield fluid 94 flows through the shield flow channel 92 during at least a portion of the time the torch is operated.

Now referring to FIG. 2 for a description of an exemplary embodiment of a system 100 for pneumatically controlling a process gas for an arc process torch (e.g., torch 18 of FIG. 1A). The system includes a pilot regulator 102, an electro-pneumatic regulator 104, a three-way valve 106, a two-way selector valve 108, and a controller 110. Each of the valves can be referred to alternatively as a valve component. A broken horizontal line 150 separates the components (e.g., the electro-pneumatic regulator 104, the controller 110, etc.) that are disposed in or near the power supply (e.g., one or more power supplies 14) or controller (e.g., controller 16) from the components (e.g., pilot regulator 102, three-way valve 106, two-way selector valve 108, etc.), that are disposed in or near the torch (e.g., torch 18). Moreover, the components disposed in or near the torch (e.g., components referenced as remote gas control (RGC) and shown to be below the broken line 150) may be positioned far from components disposed near the power supply or controller (e.g., components referenced as digital gas control (DGC) and shown above the broken line 150). That is, a cable (e.g., one or more cables 30 of FIG. 1A) connecting the torch to the power supply may be at least 3 meters in length. In some cases, the cable's length may be over 10 meters long. In some implementations, the controller 110 and/or the electro-pneumatic regulator 104 may be disposed in, or separately from, the power supply.

As noted above, the one or more cables or leads may fluidly and/or electrically couple the power supply 14 or controller 16 (and/or components disposed near the power supply 14 or controller 16) to the torch 18 and/or the components near the torch 18. For example, fluid lines P1, P2, P3, S, π1, and π2 may be representative of one or more conduits configured to conduct one or more fluids and may be disposed in one or more cables (alone or with other fluid, electrical, and/or signal conductors). Meanwhile, control lines C may be representative of one or more signal conductors configured to conduct control signals (e.g., AC or DC current) and may also be disposed in one or more cables (alone or with other fluid, electrical, and/or signal conductors).

For example, the process gas lines P1, P2, and P3 and the shield gas line S conduct process gas and shield gas, respectively, from a gas source (e.g., the power supply and/or a gas supply (not shown)) to the two-way selector valve 108 and ultimately to the torch 18. In particular, the process gas supply line P1 and the shield gas supply line S fluidly couple the gas source to inlets of the two-way selector valve 108. Additionally, process gas line P2 fluidly couples an outlet of the two-way selector valve 108 with an inlet of the pilot regulator 102. Further, process gas line P3 fluidly couples an outlet of the pilot regulator 102 to a process gas conduit in the torch 18, with the process gas conduit or line being downstream of the pilot regulator 102. FIG. 2 also depicts further fluid lines that connect the shield fluid and a coolant fluid (“W”), such as water, to another fluid selector and another pilot regulator. For brevity, these components are not discussed in detail; however, to be clear, the techniques presented herein need not be used exclusively with the process gas supply line P1 and the shield gas supply line S and could be used with any part, parts, portions, etc. of the system depicted in FIG. 2.

Still referring to FIG. 2, the pneumatic control line π1 fluidly couples an outlet of the electro-pneumatic regulator 104 to an inlet of the three-way valve or valve component 106. In this arrangement, the electro-pneumatic regulator 104 and the pneumatic control line π1 are upstream of the valve 106. The pneumatic pilot line π2 fluidly couples an outlet of the three-way valve 106 to a pilot chamber of the pilot regulator 102. In this arrangement, the pneumatic pilot line π2 is downstream of the valve 106. A control gas (e.g., air, shield gas, oxygen, or other gas supplied from the power supply 14 or a gas supply) may be conducted from the electro-pneumatic regulator 104 to the three-way valve 106 via the pneumatic control line π1, and from the three-way valve 106 to the pilot regulator 102 via the pneumatic pilot line π2.

The electro-pneumatic regulator 104 and the three-way valve 106 may adjust a pressure of the control gas based on control signals from the controller 110 received via control lines C. That is, the control lines C electrically couple the controller 110 to the electro-pneumatic regulator 104 and to the three-way valve 106. Based on the signals received from the controller 110, the electro-pneumatic regulator 104 adjusts the pressures in the pneumatic control line π1, and the three-way valve 106 either maintains or adjusts the pressure in the pneumatic pilot line π2.

The three-way valve 106 and the pilot regulator 102 provide almost instantaneous control of the gas pressure of the process gas supplied to the torch from process gas line P3. For example, the plasma gas may initially be supplied to the pilot regulator 102 at a maximum pressure (e.g., 100 psi). Then, the pilot regulator 102 can regulate or reduce the gas pressure from process gas line P2 based on a pneumatic pilot signal from the pneumatic pilot line π2. That is, the pilot regulator 102 sets the process gas line P2 pressure to the pneumatic pilot line π2 pressure based on the pneumatic control line π1 pressure. The pneumatic control line π1 is generally pressurized gas (e.g., air, shield gas, oxygen, etc.) and is controlled by a controller via the electro-pneumatic regulator 104 at or near the power supply.

In at least some instances, the pneumatic control signal is based on an anticipated current of the plasma arc during a predetermined stage of cutting operation. For example, if the stages of the cutting operation include ramp up, pierce, cut, ramp down etc., the pneumatic control signal can be controlled for each stage. Additionally, or alternatively, the pneumatic control signal can be controlled within, before, and/or after stage. Often, each stage of a cutting operation is known prior to initiation of the cutting operation and, thus, the signals can be programmed accordingly. For example, when the next stage in the cutting operation is reached, the three-way valve 106 connects the pneumatic control line π1 with the pneumatic pilot line π2 to almost change the pilot pressure instantaneously for the pilot regulator 102 and thus, the process gas line P3 pressure. Additionally, or alternatively, the pneumatic control signals can be responsive to cutting conditions and/or parameters, e.g., detected via one or more sensors monitoring a cutting process and/or a component of a plasma cutting system. In such instances, the pneumatic control system might anticipate a detected condition, prime a pressure at the three-way valve 106 accordingly and then wait until the condition is detected to effectuate the pressure change.

For example, the system 100 may be initially primed for a piercing operation and initiate a cutting stage in response to detecting that an arc has pierced a workpiece. The pneumatic control line π1 may be primed at a pressure for the cutting stage, while the pneumatic pilot line π2 is maintained at the piercing pressure. In response to detecting the arc has pierced the workpiece, the system may determine that the piercing stage is complete, and the anticipated cutting stage may be initiated. Consequently, the three-way valve 108 may connect the pneumatic control line π1 with the pneumatic pilot line π2 to almost instantaneously change the pressure of the pneumatic pilot line π2, and the process gas line P3 to the cutting pressure. Accordingly, the system 100 may monitor one or more parameters of a cutting operation to detect or determine if/when a particular stage of the cutting operation is ending or about to end, and if/when another stage of the cutting operation is starting or about to start. However, to be clear, the techniques presented herein need not be utilized between clearly defined stages and can be used during any portion of a cutting operation, including pre-cut, post-cut, or during only a portion of a cut.

Regardless of how a pressure change is initiated, the electro-pneumatic regulator 104 sends a pneumatic signal (e.g., pressurized gas) from the power supply to the pilot regulator 102 via the pneumatic control line π1 disposed in a cable. The pneumatic signal may be a desired pressure. The set pressure in the pneumatic control line π1 sets a pressure of the pneumatic pilot line π2 which in turn sets the pressure of the pilot regulator 102 all to the set pressure. The pilot regulator 102 in turn regulates the process gas line P3 pressure to the desired pressure.

As noted above, the length of the cable affects the charging time of pneumatic systems. The techniques presented herein are able to overcome this issue because the three-way valve 106 allows for pre-charging of the pneumatic control line π1 to a desired pressure before each stage of the cutting operation and/or before any desired change. That is, the pneumatic pilot line π2, and thus, the pilot regulator 102 can be held at or decreased to the desired pressure via the three-way valve 106 while the electro-pneumatic regulator 104 charges the pneumatic control line π1 to another pressure for the next cutting stage.

Once the pneumatic control line π1 is charged to a particular pressure and the three-way valve 106 is actuated to connect the pneumatic control line π1 to the pneumatic pilot line π2, the pressure of the fluid in the pneumatic pilot line π2 almost immediately matches the pressure of the fluid in the pneumatic control line π1. This is because the pneumatic control line π1 is substantially longer, and thus a substantially larger volume, than the pneumatic pilot line π2. This size and volume difference causes the pressure in the pneumatic pilot line π2 to adjust almost instantaneously to the particular pressure of the pneumatic control line π1 when the two lines are fluidly coupled by the three-way valve 106. Consequently, arrangement of the three-way valve 106 within the system 100 allows for nearly instantaneous change of pressure in the pneumatic pilot line π2, the pilot regulator 102, and process gas line P3. In some instances, almost/nearly/substantially instantaneous or instantaneously may be less than a second, less than 0.5 seconds, and/or less than 0.2 seconds and instantaneous or instantaneously may be less than 0.1 seconds and/or less than 10 milliseconds. Meanwhile, immediate or immediately may be less than 1 second and almost/nearly/substantially immediate or immediately may be less than 2 seconds and/or less than 1.5 seconds.

The three-way valve 106 includes an open position (e.g., far left position), a hold position (e.g., middle position), and a vent position (e.g., far right position). In the depicted embodiment, the three-way valve 106 is shown in the hold position. The three-way valve 106 can be controlled via solenoids using AC power, which is resistant to EMI. In some instances, the solenoids may be controlled using DC power. In some cases, the valve may be actuated pneumatically as well. In the open position, the three-way valve 106 fluidly couples the electro-pneumatic regulator 104 to the pilot regulator 102 via the pneumatic control line π1 and the pneumatic pilot line π2. In the hold position, the valve closes off the pneumatic control line π1 and pneumatic pilot line π2. Consequently, pneumatic pilot line π2 is held at its last pressure, while the pressure in the pneumatic control line π1 can be adjusted by the electro-pneumatic regulator 104 without affecting the pressure in the pneumatic pilot line π2. Finally, in the vent position, the pneumatic pilot line π2 can be vented, e.g., to the atmosphere, to reduce the pressure of the pilot regulator 102, and thus the pressure of the process gas in line P3, while the pressure in the pneumatic control line π1 can be adjusted by the electro-pneumatic regulator 104 to a desired pressure for the next cutting stage.

For example, during a ramp up stage of a cutting operation, the pneumatic control line π1 may be set to a first pressure and fluidly coupled to the pneumatic pilot line π2 and the pilot regulator 102 when the three-way valve 106 is in the open position. Once the pneumatic pilot line π2, and thus the pilot regulator 102, is set to the desired first pressure, the three-way valve 106 shifts to the hold position. In the hold position, the three-way valve 106 maintains the control gas in the pneumatic pilot line π2 and the pilot regulator 102 at the first pressure. Thus, the pilot regulator 102 regulates the dynamic pressure of the process gas in the process gas line P3 to the first pressure. Meanwhile, the pneumatic control line π1 can be charged to a second pressure based on the next stage of the cutting operation without affecting the dynamic pressure of the process gas.

When the next stage of the cutting operation is known, the system can charge the pneumatic control line π1 in advance. Then, when the cutting operation reaches the next stage, the three-way valve 106 shifts back to the open position, again fluidly coupling the electro-pneumatic regulator 104 and the charged pneumatic control line π1 with the pneumatic pilot line π2 and the pilot regulator 102. Because the pneumatic control line π1 was previously charged, the pneumatic pilot line π2 almost instantaneously jumps up or down to the second pressure upon opening of the three-way valve 106, thereby almost instantaneously changing the pressure in the pilot regulator 102 to the second pressure. In response to the change in pressure in the pneumatic pilot line π2, the pilot regulator 102 almost immediately changes the pressure of the gas in the process gas line P3 to the second pressure. The three-way valve 106 can shift back to the hold position to maintain the pressure of the pneumatic pilot line π2 and the pilot regulator 102, and thus the pressure of the process gas line P3, at the second pressure while the electro-pneumatic regulator 104 adjusts the pressure of the pneumatic control line π1 to another pressure for the next stage of the cutting operation.

Additionally, or alternatively, the three-way valve 106 may shift to the vent position to lower the pressure of the pneumatic pilot line π2, and thus the pilot regulator 102, to a desired pressure by venting the control gas to the atmosphere. Once the pneumatic pilot line π2 reaches the desired pressure, the three-way valve 106 may shift back to the hold position. Accordingly, the pilot regulator 102 maintains the process gas line P3 at the desired pressure. Meanwhile, the electro-pneumatic regulator 104 changes or maintains the pressure of the pneumatic control line π1 to/at a desired pressure based on the next stage of the cutting operation.

Accordingly, the techniques presented herein allows for almost instantaneous change and precise control of the process gas pressure over large distances via the pneumatic control system 100 that is not affected by EMI generated by an arc from the process torch. The precise and almost instantaneous control of the plasma gas reduces wear/damage of the electrode/nozzle/torch head/consumable stack/hafnium insert/etc.

In some implementations, the pilot regulator 102, the electro-pneumatic regulator 104, the three-way valve 106, the selector valve 108 and/or the torch may provide feedback to the controller 110 to determine a pressure of fluid in one or more of the fluid lines P1, P2, P3, S, π1, and π2, and/or the torch. For example, the pilot regulator 102, the electro-pneumatic regulator 104, the three-way valve 106, the selector valve 108 and/or the torch may be capable of detecting pressures of fluids flowing therethrough. Alternatively, one or more sensors for detecting fluid pressure may be disposed in or on one or more of the pilot regulator 102, the electro-pneumatic regulator 104, the three-way valve 106, the selector valve 108 and/or the torch. Additionally, or alternatively, one or more sensors for detecting pressure may be disposed in or coupled to one or more of the fluid lines P1, P2, P3, S, π1, and π2. Consequently, the controller 110 may receive feedback to control the pneumatic system 100 and/or validate that the process gas is set to a desired pressure for a particular arc process stage.

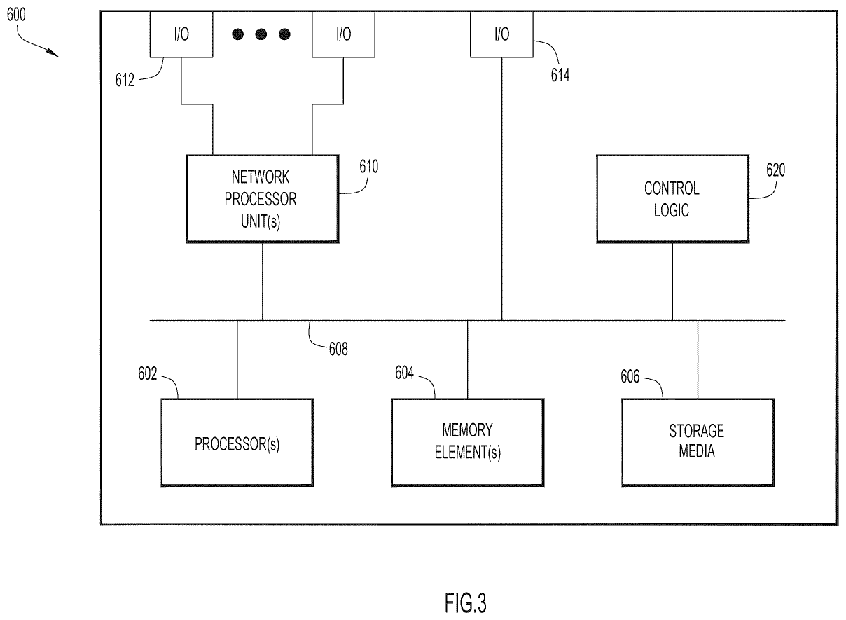

Referring to FIG. 3, a hardware block diagram of a computing device 600 is illustrated. The illustrated computing device 600 may be an example of a controller as described above. The computing device 600 may perform functions associated with the operations discussed herein in connection with the techniques described herein with reference to FIGS. 1A, 1B, and 2. The computing device 600 may be incorporated in any of the arc process system devices discussed herein and may be configured to perform the operations discussed herein for controlling one or more parameters of the arc process operation, including controlling one or more flows of fluids to the torch. Thus, any of the controller 16, the automated plasma arc torch 18, the power supply 14, and/or the positioning system 12 of an automated cutting system 10 may execute the techniques presented herein, alone or in combination with one or more other systems/components.

In at least one embodiment, the computing device 600 may be any apparatus that may include one or more processor(s) 602, one or more memory element(s) 604, storage media 606, a bus 608, one or more network processor unit(s) 610 interconnected with one or more network input/output (I/O) interface(s) 612, one or more I/O interface(s) 614, and control logic 620. In various embodiments, instructions associated with logic for the computing device 600 can overlap in any manner and are not limited to the specific allocation of instructions and/or operations described herein.

In at least one embodiment, the processor(s) 602 is/are at least one hardware processor configured to execute various tasks, operations and/or functions for the computing device 600 as described herein according to software and/or instructions configured for the computing device 600. The processor(s) 602 can execute any type of instructions associated with data to achieve the operations detailed herein. In one example, the processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term “processor.”

In at least one embodiment, the memory element(s) 604 and/or the storage media 606 is/are configured to store data, information, software, and/or instructions associated with the computing device 600, and/or logic configured for the memory element(s) 604 and/or the storage media 606. For example, any logic described herein (e.g., the control logic 620) can, in various embodiments, be stored for the computing device 600 using any combination of the memory element(s) 604 and/or the storage media 606. Note that in some embodiments, the storage media 606 can be consolidated with memory element(s) 604 (or vice versa) or can overlap/exist in any other suitable manner.

In various embodiments, any entity, apparatus, or device as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad terms “memory element” and “storage media.” Data/information being tracked and/or sent to one or more entities, apparatuses, or devices as discussed herein could be provided in any database, table, register, list, cache, storage, and/or storage structure: all of which can be referenced at any suitable timeframe. Any such storage options may also be included within the broad terms “memory element” and “storage media” as used herein.

Note that in certain example implementations, operations as set forth herein may be implemented by logic (as described herein; e.g., the control logic 620) encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software (potentially inclusive of object code and source code), etc.) for execution by the one or more processor(s) 602, and/or other similar machine(s), etc. Generally, this includes the memory element(s) 604 and/or the storage media 606 being able to store data, software, code, instructions (e.g., processor instructions), logic (e.g., the control logic 620), parameters, combinations thereof, or the like that are executed to carry out operations in accordance with teachings of the present disclosure.

To the extent that embodiments presented herein relate to the storage of data, the embodiments may employ any number of any conventional or other databases, data stores or storage structures (e.g., files, databases, data structures, data, or other repositories, etc.) to store information.

In at least one embodiment, the bus 608 can be configured as an interface that enables one or more elements of the computing device 600 to communicate in order to exchange information and/or data. The bus 608 can be implemented with any architecture designed for passing control, data and/or information between the processor(s) 602, the memory elements 604, the storage media 606, peripheral devices, and/or any other hardware and/or software components that may be configured for the computing device 600. In at least one embodiment, the bus 608 may be implemented as a fast kernel-hosted interconnect, potentially using shared memory between processes (e.g., logic), which can enable efficient communication paths between the processes.

In various embodiments, the network processor unit(s) 610 may enable communication between the computing device 600 and other systems, entities, devices, etc., via the network I/O interface(s) 612 (wired and/or wireless) to facilitate operations discussed for various embodiments described herein. In various embodiments, the network processor unit(s) 610 can be configured as a combination of hardware and/or software, such as one or more Ethernet driver(s) and/or controller(s) or interface cards, Fiber Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between the computing device 600 and other arc process system devices, arc process system auxiliary components, etc. to facilitate the operations described herein. In various embodiments, the network I/O interface(s) 612 can be configured as one or more Ethernet port(s), Fiber Channel ports, any other I/O port(s), and/or antenna(s)/antenna array(s) now known or hereafter developed. Thus, the network processor unit(s) 610 and/or the network I/O interface(s) 612 may include suitable interfaces for receiving, transmitting, and/or otherwise communicating data and/or information in a network environment.

The I/O interface(s) 614 allow for input and output of data and/or information with other entities that may be connected to the computer device 600. For example, the I/O interface(s) 614 may provide a connection to arc process system devices and/or components. In some implementations, the I/O interface(s) 614 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, the control logic 620 can include instructions that, when executed, cause the processor(s) 602 to perform operations, which can include, but are not limited to: controlling the pressure of one or more fluids supplied to the torch, changing various parameters of the arc process operation; providing overall control operations of the arc process system; interacting with other entities, devices, components, systems, etc. described herein; maintaining and/or interacting with stored data, information, parameters, etc. (e.g., the memory element(s) 604, the storage media 606, data structures, databases, tables, etc.); and/or combinations thereof to facilitate various operations for embodiments described herein.

The programs described herein (e.g., the control logic 620) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

References herein to various features (e.g., elements, structures, nodes, modules, components, engines, logic, steps, operations, functions, characteristics, etc.) included in “one embodiment”, “example embodiment”, “an embodiment”, “another embodiment”, “certain embodiments”, “some embodiments”, “various embodiments”, “other embodiments”, “alternative embodiment”, and the like are intended to mean that any such features are included in one or more embodiments of the present disclosure, but may or may not necessarily be combined in the same embodiments. Note also that a module, engine, client, controller, function, logic or the like as used herein, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

While the invention has been illustrated and described in detail and with reference to specific embodiments thereof, it is nevertheless not intended to be limited to the details shown, since it will be apparent that various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

Reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above,” “below,” “upper,” “lower,” “top,” “bottom,” or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions and/or other characteristics (e.g., time, pressure, temperature, distance, etc.) of an element, operations, conditions, etc., the phrase “between X and Y” represents a range that includes X and Y.

For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment.

Further, the present disclosure may repeat reference numerals and/or letters in the various examples. This repetition is for the purpose of simplicity and clarity and does not in itself dictate a relationship between the various embodiments and/or configurations discussed.

Similarly, when used herein, the term “comprises” and its derivations (such as “comprising,” etc.) should not be understood in an excluding sense, that is, these terms should not be interpreted as excluding the possibility that what is described and defined may include further elements, steps, etc. Meanwhile, when used herein, the term “approximately” and terms of its family (such as “approximate,” etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially”.

As used herein, unless expressly stated to the contrary, use of the phrase “at least one of,” “one or more of,” “and/or,” variations thereof, or the like are open-ended expressions that are both conjunctive and disjunctive in operation for any and all possible combination of the associated listed items. For example, each of the expressions “at least one of X, Y and Z,” “at least one of X, Y or Z,” “one or more of X, Y and Z,” “one or more of X, Y or Z” and “X, Y and/or Z” can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms “first,” “second,” “third,” etc., are intended to distinguish the particular nouns they modify (e.g., element, condition, node, outlet, inlet, valve, module, activity, operation, etc.). Unless expressly stated to the contrary, the use of these terms is not intended to indicate any type of order, rank, importance, temporal sequence, or hierarchy of the modified noun. For example, “first X” and “second X” are intended to designate two “X” elements that are not necessarily limited by any order, rank, importance, temporal sequence, or hierarchy of the two elements. Further as referred to herein, “at least one of” and “one or more of” can be represented using the “(s)” nomenclature (e.g., one or more element(s)).

1. A process gas control system for a plasma torch, the process gas control system comprising:
a gas source;
a first regulator connected to the gas source;
a valve component having multiple modes of operation;
a first line connected to the first regulator and to the valve component, the first line supplying a gas from the first regulator to the valve component, the gas in the first line being at a first pressure;
a second regulator; and
a second line connected to the valve component and to the second regulator, the second line supplying a gas from the valve component to the second regulator, the gas in the second line being at a second pressure, wherein the valve component controls the second pressure in the second line.

2. The process gas control system of claim 1, wherein the first line is a pneumatic control line and the second line is a pneumatic pilot line.

3. The process gas control system of claim 2, wherein the multiple modes of operation of the valve component are an open mode, a hold mode, and a vent mode.

4. The process gas control system of claim 3, wherein, in the open mode, the valve component fluidly couples the first regulator to the second regulator via the first line and the second line.

5. The process gas control system of claim 4, wherein, in the hold mode, the valve component closes off the first line and the second line, and the gas in the first line can be adjusted by the first regulator to be at a third pressure while the second line is held at the second pressure.

6. The process gas control system of claim 5, wherein, in the vent mode, the second line can be vented to reduce a pressure of the second regulator and a pressure of gas in a line downstream of the second regulator.

7. The process gas control system of claim 1, wherein the first regulator is an electro-pneumatic regulator that is closer to the gas source than to the plasma torch, and the valve component is closer to the plasma torch than to the gas source.

8. The process gas control system of claim 1, wherein the valve component is a three-way valve.

9. A process gas control system for a plasma torch, the process gas control system comprising:
a gas source;
a first regulator connected to the gas source;
a three-way valve having a plurality of operational modes;
a first pneumatic line connected to the first regulator and to the three-way valve, the first pneumatic line supplying a gas from the first regulator to the three-way valve;
a second regulator;
a second pneumatic line connected to the three-way valve and to the second regulator, the second pneumatic line supplying a gas from the three-way valve to the second regulator; and
a process gas line downstream of the second regulator, wherein a pressure of gas in the second pneumatic line and a pressure of gas in the process gas line can be adjusted relative to a pressure of gas in the first pneumatic line by the three-way valve being in a particular one of its plurality of operational modes.

10. The process gas control system of claim 9, wherein the first regulator is an electro-pneumatic regulator that is closer to the gas source than to the plasma torch, and the three-way valve is proximate to the plasma torch.

11. A method of operating a process gas control system for a plasma torch, the process gas control system including a gas source, a valve component, a first pneumatic line upstream of and connected to the valve component and supplying a gas from the gas source to the valve component, a second pneumatic line downstream of and connected to the valve component, the method comprising the steps of:
controlling the valve component to be in an open position;
adjusting gas in the first pneumatic line to be a first pressure;
fluidly coupling the first pneumatic line to the second pneumatic line so that a pressure of gas in the second pneumatic line is at the first pressure; and
upon determining that the gas in the second pneumatic line is at the first pressure, controlling the valve component to be in a hold position.

12. The method of claim 11, wherein the process gas control system includes a pilot regulator connected to the second pneumatic line, and when the valve component is in the hold position, each of a pressure of gas in the first pneumatic line and a pressure of gas in the pilot regulator is maintained at the first pressure.

13. The method of claim 12, wherein the process gas control system includes a process gas line downstream of the pilot regulator, and when the valve component is in the hold position, the method further comprises the step of:
regulating, via the pilot regulator, a pressure of process gas in the process gas line to be at the first pressure.

14. The method of claim 13, wherein, when the valve component is in the hold position, the method further comprises the step of:
adjusting the gas in the first pneumatic line to be at a second pressure different from the first pressure without affecting the pressure of the process gas in the process gas line.

15. The method of claim 14, wherein the process gas control system includes an electro-pneumatic regulator upstream of the valve component, and the method further comprises the step of:
controlling the valve component to be in the open position so that the electro-pneumatic regulator and the first pneumatic line are fluidly coupled with the second pneumatic line and the pilot regulator, and a pressure of the gas in the second pneumatic line quickly adjusts to the second pressure.

16. The method of claim 15, wherein, when the pressure of the gas in the second pneumatic line is at the second pressure, the pilot regulator substantially immediately changes a pressure of the gas in the process gas line to the second pressure.

17. The method of claim 16, further comprising the step of:
controlling the valve component to the hold position, wherein a pressure of gas in the second pneumatic line, a pressure of gas in the pilot regulator, and a pressure of gas in the process gas line are maintained at the second pressure.

18. The method of claim 17, further comprising the step of:
controlling the electro-pneumatic regulator to adjust a pressure of gas in the first pneumatic line to be at a third pressure for a subsequent cutting operation.

19. The method of claim 18, further comprising the step of:
controlling the valve component to a vent position to lower a pressure of gas in the second pneumatic line and the pilot regulator to a fourth pressure by venting at least some of the gas in the second pneumatic line to atmosphere.

20. The method of claim 19, wherein, when gas in the second pneumatic line reaches the fourth pressure, the method further comprises the step of:
controlling the valve component back to the hold position.
